(19) United States
(12) Patent Application Publication
(10) Pub. No.: US 2017/0251794 A1
(43) Pub. Date: Sep. 7, 2017

(54) CLIP OF AN ITEM HOLDER

(71) Applicants: Bretislav KOSTAL, Praha 10 (CZ); Vladimir Kupa, Praha 5 (CZ)

(72) Inventors: Bretislav KOSTAL, Praha 10 (CZ); Vladimir Kupa, Praha 5 (CZ)

(21) Appl. No.: 15/441,310

(22) Filed: Feb. 24, 2017

(30) Foreign Application Priority Data
Mar. 1, 2016 (CZ) 2016-120

(51) Int. Cl. A45F 5/02; F16B 2/22

(52) U.S. Cl. CPC A45F 5/021; F16B 2/22

(57) ABSTRACT

A clip for an item holder with a clamping wall and connecting elements for the holder with a clamping wall provided with opposing guiding plates ending with a semi-circular bottom and lateral surfaces with a pivoting catch between them and with a spring that pushes the pivoting catch on the inner side of the guiding plates. The clamping wall has a partition on its back side that defines a space in the clamping wall to insert attaching elements to the holder.

### BACKGROUND OF THE INVENTION

The invention concerns a clip of an item holder with a clamping wall and connecting elements for the holder.

### BRIEF SUMMARY OF THE INVENTION

Clips for holders are designed to attach holders of personal items, particularly on various parts of gear or clothing, e.g. on a belt. The attached items may include light firearms or weapons, as well as flashlights, various tools etc., which may be attached directly on the gear to guarantee easy access for the user. The attaching mechanism of the holder and of the clip may be the same for several types of holders and one clip thus may be used to connect several types of items.

An example of a clip with outside straps adjustable to the belt width is a clip made based on EP 1604587. The clip is attached to a holder with an attachment mechanism containing screw connections and the mutual bearing surfaces of the holder and of the clip are provided with interlocking round toothing which, if the right pressure is applied, enable to turn the holder and the respective item into a desired angle position in respect to the belt and to keep the holder in the desired position.

Another simple variant of the clip is shown in the industrial design RCD 0022236324. In this clip the outer straps are replaced with an enclosed sleeve to slide on a belt. The sleeve is inside provided with a moving adapter that allows to set up a gap between the bearing surfaces of the sleeve based on the belt's width. A similar screw connection is used to attach the holder to the clip as in the above described variant.

One of the potential variants of the holder designed for a pocket flashlight and suitable for attachment to the clip described above is shown in RCD 001958181. On its surface facing the clip the holder is provided with an opening with round toothing along its perimeter and a system of pins as a part of the attaching mechanism. In combination with the clip the toothing fits into the corresponding toothing on the front side of the clip and the pins fit into openings in the adapter placed on the back side of the front wall of the clip. The adapter is attached to the holder with a screw connection. This attachment mechanism allows, identically as the variant according to the above-described European patent, to turn the holder into different positions in respect to the belt.

One disadvantage of the above-described clips consists in the screw connection between the clip and the holder which is reliable but its installation requires certain time and skills to handle the relatively small pieces that make up the connection. This also implies that it is practically impossible to attach a given clip to a different holder.

The purpose of the invention is to create a clip with a design allowing fast and, at the same time, safe replacement of different holders attached to the clip without using a screw connection.

### SUMMARY OF THE INVENTION

The invention of a clip for a holder of items with a clamping wall and connecting elements for the holder consists in the fact that the clamping wall is provided with opposite guiding plates ended with a semi-circular bottom and lateral surfaces, a pivoting catch and with a spring pushing the pivoting catch arm on the inner side to the guiding plates.

Subsequently, other possible variants of the invention are provided which further develop or specify its significant features.

The clamping wall is on its back side provided with a partition which defines a space in the clamping wall to insert connecting elements to the holder.

A round toothing is located on the clamping wall along the perimeter of the semi-circular bottom.

The pivoting catch is in the form of a two-armed lever with a controlled upper arm.

The clamping wall is attached to the back wall via lateral surfaces and a bridge so that a space is created between the clamping wall and the back wall to insert a belt or harness.

In the space between the clamping wall and the back wall there is an adapter containing means to secure it's position between the clamping wall and the back wall.

The key advantage of the clip according to this invention consists in easy and fast connection/disconnection of the item holder to/from the clip while keeping the opportunity to turn the items into different positions with regard to the clip and keeping the holder in that position. Another advantage is that the clip is more universal and therefore the holders, and thus also the items, attached to one clip may be easily and safely replaced.

### DESCRIPTION OF THE DRAWINGS

The clip for attachment of replaceable holders on a belt is shown in the enclosed drawing, where:

FIG. 1—is a front perspective view of the clip.

FIG. 2—is a front perspective view of the securing element of the clip.

FIG. 3—is a cross section of the clip and connection parts of the holder.

### DETAILED DESCRIPTION OF THE INVENTION

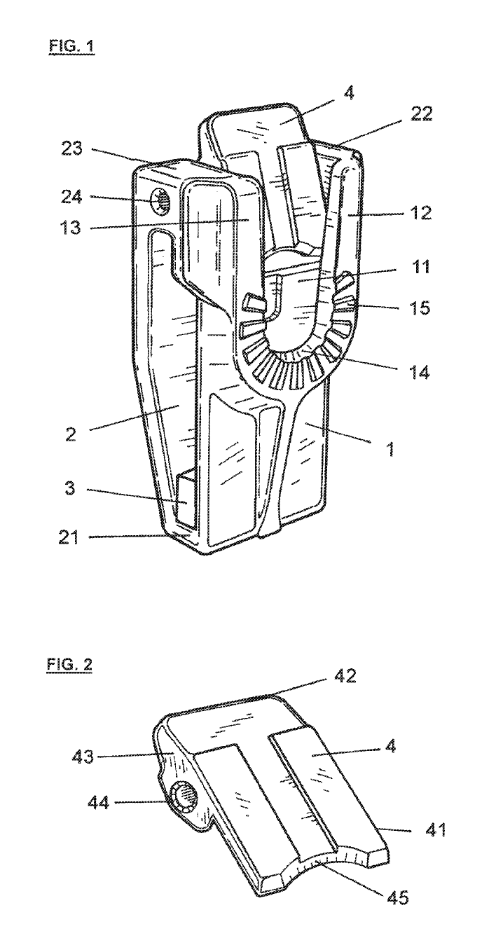

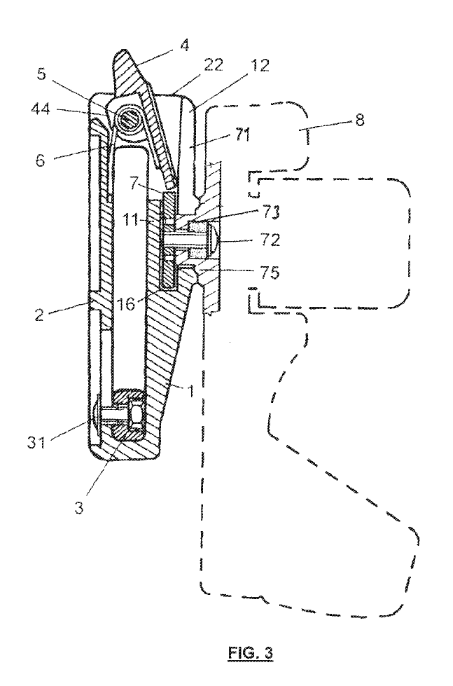

The example shows one of the possible embodiments of the clip for a holder, specifically for attachment to a belt. As shown in the view of FIG. 1 and in the cross-section in FIG. 3, the clip has a clamping wall 1 and a back wall 2 that are mutually connected with a bridge 21 in the bottom part and with two opposite lateral surfaces 22 and 23 in the upper part. The belt is to be inserted into the space between the walls. The clamping wall 1 continues with the lateral surfaces 22 and 23 and guiding plates 12 and 13 ended with a semi-circular bottom 14. The semi-circular bottom 14 in the clamping wall 1 is provided with an interrupted planar round toothing 15. The cross-section of FIG. 3 shows that the clamping wall 1 is partly doubled inside by means of a partition 11 and therefore free space 16 is created between the partition 11 and the guiding plates 12 and 13. Between the guiding plates 12 and 13 there is a securing element of the clip created as a pivoting catch 4. The pivoting catch is turning on a pin 5 inserted into openings 24 in the lateral surfaces 22 and 23. As shown in detail in FIG. 2, the pivoting catch 4 has an upper arm 42 and a lower arm 41 ending with a concave surface 45. Between the arms 41 and 42 the pivoting catch 4 is provided with side projections 43 with openings 44 to insert the pin 5. On the central free part of the pin 5 there is a spring 6, with one of its arms propped against the inner surface of the back wall 2 and the other arm against the pivoting catch 4, The spring 6 thus pushes the pivoting catch 4 on the inner surface of the guiding plates 12 and 13.

The guiding plates 12 and 13 are designed to insert attaching elements of the holder 8. In FIG. 3 the holder is only outlined, with the exception of the attaching elements shown in the cross-section. The elements include a nut 7 and a cylindrical lug 71, to which the nut 7 is attached with a screw connection 72, and also the planar round toothing 75 that is complementary to the circular toothing 15 on the clip.

In the space between the clamping wall 1 and the back wall 2 there is a moving adapter 3 with a screw connection 31. The free part of the screw connection 31 is placed in a groove in the back wall 2 which allows to set up and to fix the adapter 3 in a position that defines the size of the free space between the walls so that it is appropriate for the belt height.

In order to attach the holder 8 to the clip the cylindrical lug 71 with the nut 7 is inserted from above between the guiding plates 12 and 13. At the same time, the pivoting catch 4 is pushed into the inner space of the clip and the nut 7 is inserted into the free space 16 behind the partition 11. In a position when the cylindrical lug 71 gets into contact with the semi-circular bottom 14 and the nut is under the lower arm 41 and under the concave surface 45 of the pivoting catch 4, the pivoting catch 4 is released and falls back on the inner side of the guiding plates 12 and 13. The nut 7 props against the inner surface 45 of the arm 41 and this secures safe attachment of the holder 8 in the clip. The planar round toothing 15 on the clamping wall 1 and the complementary planar round toothing 75 on the back side of the holder 8 form an interface between the clip and the holder 8, while the surfaces are pushed against each other by an elastic element 73. The cylindrical shape of the lug 71 allows its turning on the semi-circular bottom 14 and the mutually interlocking planar toothing on the clamping wall 1 of the clip and on the back side of the holder 8 fix the holder on the clip, while the strength of the fixing is defined by prestressing of the elastic element 73.

The holder is taken out from the clip by pressing the upper arm 42 of the pivoting catch 4 towards the guiding plates 12 and 13. The surface 45 thus releases the nut 7 and the entire holder 8 can be taken out from the clip in the direction away from the semi-circular bottom 14.

The clip for the item holder is not limited to the application described above, i.e. attachment to a belt. To attach the clip to a different part of gear or clothing the clip does not need the back wall and its clamping wall may be provided with another suitable clamping element, including a screw connection.

### INDUSTRIAL APPLICABILITY

The clip of the invention may be used, in combination with various holders, to suspend any type of personal items on parts of the gear or clothing or, if applicable, other equipment. The personal items may include truncheons, various defensive and offensive weapons etc., used e.g. by riot police, fire services or army. The clip may be used by other professionals as well, e.g. for works at height, mountain climbing etc.

1. A clip for an item holder with a damping wall and connecting elements for the holder, wherein the clamping wall is provided with opposing guiding plates ending with a semi-circular bottom and lateral surfaces and with a pivoting catch between them with a spring that pushes the pivoting catch on the inner side of the guiding plates.

2. The clip according to claim 1, wherein the clamping wall has a partition on its back side that defines a space in the clamping wall to insert attaching elements to the holder.

3. The clip according to claim 1, wherein a round toothing is located along the perimeter of the semi-circular bottom on the clamping wall.

4. The clip according to claim 1, wherein the pivoting catch is in the form of a double-arm lever with a controlling upper arm.

5. The clip according to claim 1, wherein the back wall is attached to the clamping wall with lateral surfaces and a bridge so that between the clamping wall and the back wall there is a space to insert a belt or harness.

6. The clip according to claim 5, wherein an adapter is inserted in the space between the clamping wall and the back wall with means to secure its position between the clamping wall and the back wall.
